(19) United States
(12) Patent Application Publication
(10) Pub. No.: US 2008/0159287 A1
(43) Pub. Date: Jul. 3, 2008

(54) EFFICIENT PERFORMANCE MONITORING USING IPv6 CAPABILITIES

(75) Inventors: Ramesh Nagarajan, Princeton Junction, NJ (US); Shyam P. Parekh, Orinda, CA (US); Kiran M. Rege, Marlboro, NJ (US)

Correspondence Address: SYNNESTVEDT & LECHNER, LLP, 1101 MARKET STREET, SUITE 2600, PHILADELPHIA, PA, 19107-2950, US

(73) Assignee: LUCENT TECHNOLOGIES INC., Murray Hill, NJ (US)

(21) Appl. No.: 11/617,837

(22) Filed: Dec. 29, 2006

(51) Int. Cl. H04L 12/56

(52) U.S. Cl. 370/392; 370/252

(57) ABSTRACT

The present invention provides a method for obtaining and reporting performance information on node-to-node data transfers, i.e., network hops, based on integrated capabilities in Internet Protocol version 6 (IPv6), specifically extension headers. The performance of a (real-time) data flow is monitored between a source-destination pair by inserting specific information in an extension header of select data packets in the data flow. By initiating an extension header at a source client, and updating the extension header at any intermediate nodes along the source-destination path, a destination node can produce a detailed set of statistics relating to the current performance level of select nodes in a network based upon the reported data in the extension header. Additionally, data flow performance can be monitored on any desired network path or segment independent of particular flows on those paths.

### FIELD OF THE INVENTION

The invention pertains to performance monitoring in packet based networks, specifically IP-based packet networks.

### BACKGROUND OF THE INVENTION

In the past decade, computer networks have grown massive in both size and performance capabilities. While the network elements, e.g. routers, switches, etc., that support these networks have scaled up in capacity as well, they are still vulnerable to occasional congestion and resulting performance degradation caused by temporary overloads where the load on a network element significantly exceeds its capacity.

One response to network element performance degradation has been the development of Quality of Service (QoS) monitoring applications. These applications are used to monitor network performance and diagnose problems such as node congestion, packet delay, or broken links in the network. This type of monitoring application may be considered to be a small part of a larger suite of operation, administration and maintenance applications (OAM). OAM refers to mechanisms used in networks to ease operation and reduce operational costs. It may also be used for verifying network performance and preventing failures.

Several OAM applications or utilities are currently available for monitoring the performance of a network. One widely used OAM utility is the PING mechanism for IP based packet networks. PING sends a series of packets to a destination, and, upon the packets' return, reports statistics such as the total delay and the total number of packets lost between the origin and the destination of the packets. Another popular OAM utility is TRACEROUTE. TRACEROUTE provides a listing of each node or router between the origin and the destination, and also provides delay samples between the origin and each intermediate node. The Internet Control Message Protocol (ICMP) based delay measurement techniques employed by PING and TRACEROUT are known to be unreliable indicators of absolute performance as the processing delays at the routers along the path tend to be highly variable. PING and TRACEROUTE were designed for connectivity checks and rough delay estimates rather than as accurate performance verification tools.

Another performance monitoring tool utilizes a management information base (MIB) for each router on a particular network. Each router collects aggregate statistics, such as the number of packets in, the number of packets out, and total delays per interface or per traffic class. This aggregate information is stored in the MIB for that specific router. This information is typically collected by network performance management platforms via protocols such as SNMP.

The maintenance tools discussed above are useful for monitoring overall network performance, or overall performance at an individual router in a network, but do not provide a means for monitoring network performance for a single data flow. They merely provide a snapshot of the performance of a network element over a period of time, e.g., a single day, showing different statistics for the entire period. What is needed is a maintenance tool that can be used to monitor the performance of a network by tracing a single data flow through the nodes of the network, one network hop at a time, recording performance information specific to an individual data flow.

### SUMMARY OF THE INVENTION

The present invention provides a method for obtaining and reporting performance information on node-to-node data transfers, i.e., network hops, based on integrated capabilities in Internet Protocol version 6 (IPv6), specifically extension headers. The performance of a (real-time) data flow is monitored between a source-destination pair by inserting specific information in an extension header of select data packets in the data flow. Additionally, data flow performance can be monitored on any desired network path or segment independent of particular flows on those paths.

In a first embodiment, the source node of a data flow periodically inserts a hop-by-hop extension header into packets belonging to that flow, and each node on the flow's source-destination route updates this extension header. The extension header includes a “Quality of Service (QoS) Reporting” option which includes a sequence number and identifiers of QoS metrics that are to be reported by each node on the path of the data flow. The sequence number and identifiers of QoS metrics are inserted by a monitoring function operating at the source node of the data flow. The QoS-Reporting option in the extension header is updated at every routing node on the source-destination route. Each node on the path of the data flow records (in the extension header) information such as time-stamp, packets received, consecutive packet loss count, etc. Once the packet carrying the extension header reaches the destination node, all of the above per-hop information is received by the destination-side monitoring function. On receiving this information, the destination-side monitoring function assembles a detailed performance profile for each of the hops along the path. The timestamps are used to determine both the total delay encountered along the route and individual per-hop delays. The difference in packets received at successive routers determines the packet loss per hop. Additional recorded information is also used to determine any other desired performance characteristics, such as consecutive packet loss.

In a second embodiment, any node in the network can create an independent network path monitoring flow by using a similar process as described above. However, as opposed to monitoring an existing data flow, the node initiates a data flow solely for the purpose of testing route performance. This testing process can be used sporadically to monitor the performance of a particular route in a network regardless of whether a data flow is present. Similar to above, a destination node can collect information contained in the extension headers and compile the information to create an overview of network performance.

### BRIEF DESCRIPTION OF THE DRAWINGS

FIG. 1 is a block diagram illustrating a local area network according to principles of the present invention.

FIG. 2a is a data packet according to IPv6 standards.

FIG. 2b is an options portion of an extension header according to IPv6 standards.

FIG. 3 is a flow chart illustrating a particular embodiment of the present invention.

FIG. 4a is a hop-by-hop extension header created by a source client in accordance with the present invention.

FIG. 4b is a hop-by-hop extension header after it has been modified, in accordance with the present invention, by a router on the path toward the destination.

FIG. 4c is a hop-by-hop extension header with a null QoS-Reporting option in accordance with the present invention.

### DETAILED DESCRIPTION OF THE INVENTION

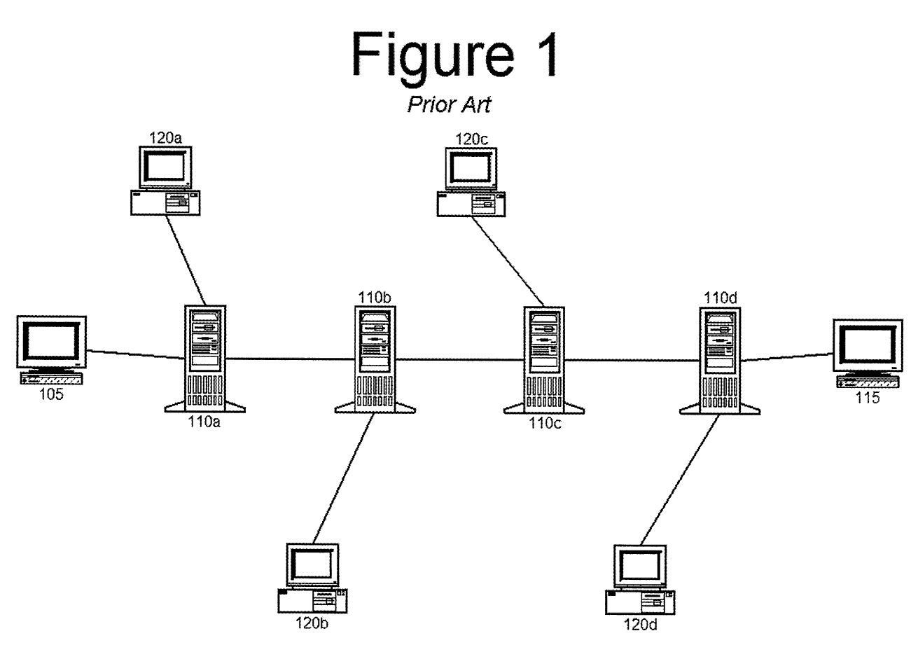

The present invention provides a process for utilizing the IPv6 feature of hop-by-hop extension headers to improve monitoring and maintenance of IPv6 networks. FIG. 1 illustrates a simple data network 100. Source client 105 sends a packet to destination client 115 by utilizing routers 110 a-d. Source client 105 addresses a data packet with the destination address being the network address of destination client 115. Router 110a receives the packet and checks the destination address. After determining it is not the final destination of the data packet, router 110a forwards the packet to router 100b. This process continues through routers 110c and 110d until the packet reaches destination client 115.

Clients 120 a-d are also operably connected to network 100, and can be sending data packets throughout the network as well. These additional data flows can result in any individual router 110 a-d being busy when receiving the packet originating from source client 105. This results in a packet delay and possible packet loss at the busy router.

Using existing techniques to monitor the network performance, source client 105 can obtain the total delay and total packets lost for a single data flow from the destination client 115, but the performance of the individual routers for the single data flow between clients 105 and 115 is unavailable.

In the present invention, the source client 105 periodically inserts a hop-by-hop extension header into an outgoing packet belonging to a data flow being routed to destination client 115. The hop-by-hop extension header, referred to hereafter as the extension header, includes a QoS-Reporting option, which, in turn, includes a sequence number, assigned by the source client 105 that is used to track the data flow in the network. The extension header also includes identifiers of different statistical data pertaining to that flow that are to be collected. Besides the identifiers of the statistical data to be reported by nodes on the path of the data flow, the source client also includes the initial values of these data in the corresponding fields within the extension header. At router 110 a, the extension header is updated to include locally collected statistical data concerning the data flow as requested by the source client. This continues through each of the remaining routers between source client 105 and destination client 115. Once destination client 115 receives the packet, it can construct a set of performance statistics based on the accumulated data contained in the packet's extension header. The process of monitoring a data flow is explained in more details below in the discussion of FIG. 3.

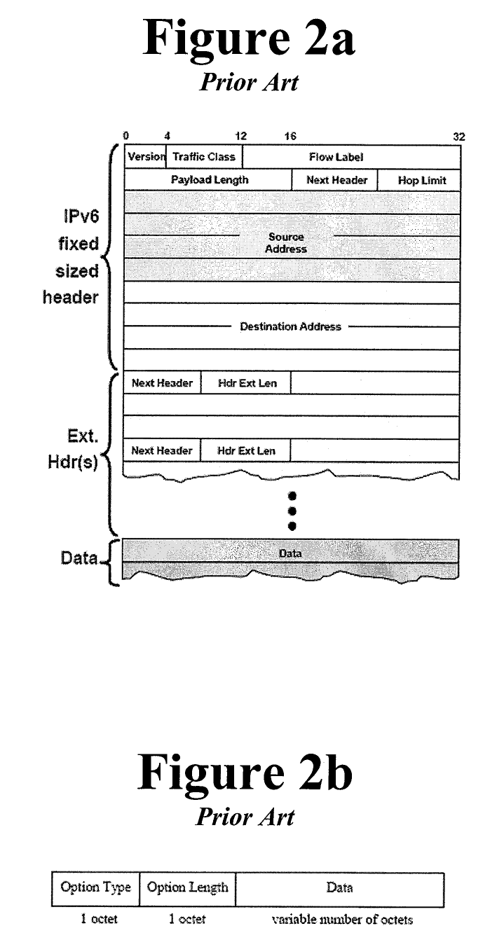

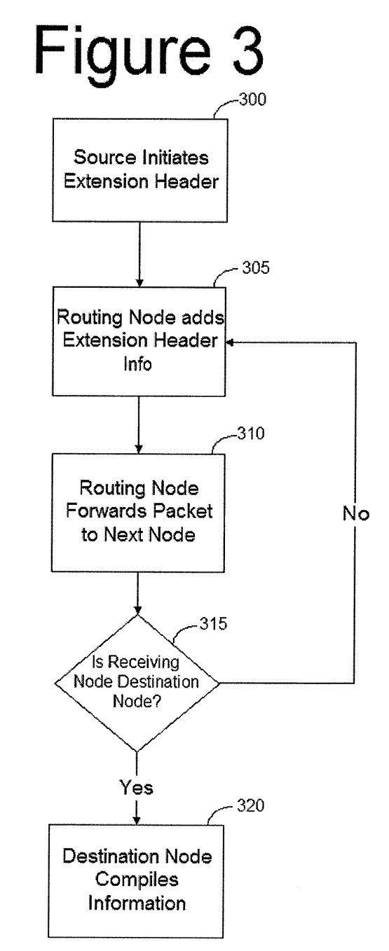

FIG. 2a illustrates a data packet as standardized by IPv6. The present invention specifically makes use of the extension headers introduced in IPv6. The IPv6 specification allows for six types of extension headers: Hop-by-Hop, Routing, Fragment, Destination Options, Authentication, and Encapsulating-Security-Payload. Except for the Hop-by-Hop and Routing extension headers, all the other extension headers are processed only at the node specified by the destination address in the IPv6 header. Routing extension headers are used for source routing, i.e., to list the intermediate nodes to be visited. Similarly, Hop-by-Hop extension headers are processed by each intermediate router. Note, however, that the IPv6 standard only specifies the format/framework but does not suggest any particular uses of these extension headers.

Extension headers can be stitched together using the Next Header field as shown in FIG. 2a. If the data packet includes multiple extension headers, the Next Header field of an extension header points to the next extension header. Finally, the Next Header field of the last extension header in this sequence points to the header of the transport layer protocol, such as TCP or UDP, and the actual payload of the IP packet. When the Next Header field is utilized, the recipient of the packet infers that the next extension header has relevant information. The rationale for adopting such a system is to separate additional services from basic services, put them in extension headers, and further categorize extension headers by their function. By doing so, the burden placed on individual routers is lessened, and a system is established that allows flexible addition of functions.

FIG. 2b illustrates an options portion of a Hop-by-Hop extension header. Several types of information can be reported in a Hop-by-Hop extension header by exploiting this, i.e., options, feature. The present invention utilizes this feature to report information such as a timestamp, packets received, consecutive packets lost and other statistical data that a monitoring program may require for monitoring the performance of a network. Specific details of the header and option creation and update are explained below in the discussion of FIG. 3.

FIG. 3 illustrates a flow chart schematically representing the actions of network entities such as clients and routers according to a particular embodiment of the present invention. In step 300, a source client, such as client 105 in FIG. 1, initiates a data flow. In the initial packet of the data flow, the source client addresses the packet to a destination address, such as the address of client 115 in FIG. 1. In this example, source client 105 is interested in identifying the routers on the path and monitoring packet delays and packet losses on a per-hop basis between itself and the destination client 115.

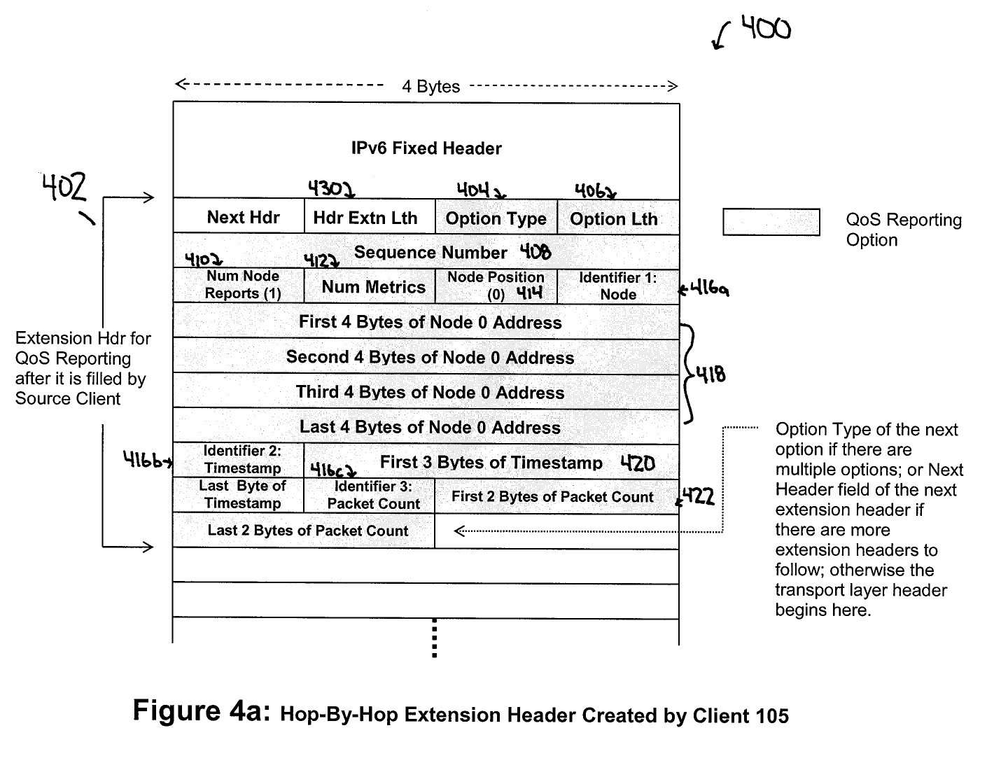

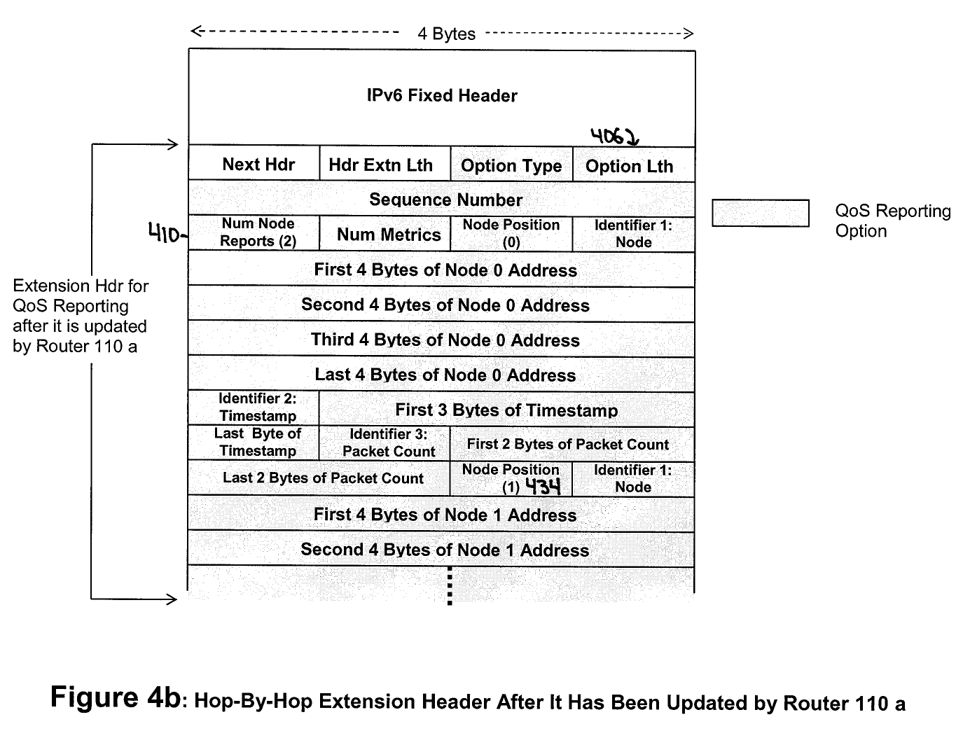

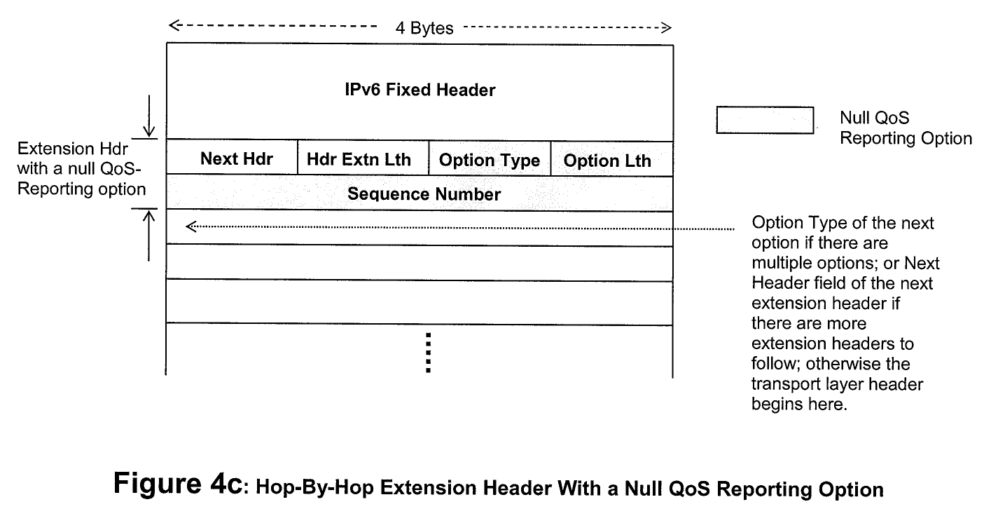

In order to facilitate this performance monitoring, the source client creates a hop-by-hop extension header 402 within data packet 400, as shown in FIG. 4a. According to the present invention, a special Option Type (1 byte) is used to indicate the extension header is being used as a QoS-Reporting header. Thus, the source client 105 fills the Option Type field 404 to indicate a QoS-Reporting header. The Option Length field 406 follows the Option Type field 404. The Option Length field 406 is used by the client to indicate the length of the QoS reporting portion of the extension header. This QoS reporting portion is indicated by the shaded portion of FIG. 4a. The first field that appears after the Option Length field 406 is the Sequence Number field 408.

When the source client 105 initiates QoS reporting for a given data flow, the Sequence Number field 408 in the QoS-Reporting extension header of the first packet associated with that data flow is set to 0. After that, whenever a packet associated with that data flow with a QoS-Reporting extension header is transmitted by the source client 105, the “Sequence Number” field is incremented by 1.

The “Number of Node Reports” field 410 is set to 1 by the source client, and is incremented by 1 by every node on the path to the destination that includes its QoS reporting data in the extension header. The source client 105 fills in the next field, the “Number of Metrics” field 412, with the number of QoS related data it wants network nodes to report. In the present example, this field is set to 3 by the source client 105 since it is interested in the (1) identities, or addresses, of the nodes that appear on the path to the destination client, (2) the time taken by packets to traverse each hop and (3) the packet loss per hop.

The field that appears after “Number of Metrics” field 412 is “Node Position” field 414. The source client 105 fills in this field with a 0, which is deemed to be its position on the data path between the source client and the destination client. Note that, to instruct network nodes to collect and report the desired performance data, the source client uses a code to identify the data to be reported. This code, labeled Identifier in FIG. 4a, fields 416a, 416b and 416c, always precedes the corresponding data in the QoS-Reporting option. Identifier 1 field 416a is used to indicate that the first reported piece of data will be node address. Following field 416a, field 418 is used to report the entire address of the reporting node. Note that, in an actual packet, field 418 comprises 16 contiguous bytes of data. It is only because of the way FIG. 4a has been drawn—showing 4 bytes per row in accordance with common practice—that makes field 418 appear to be spread over four rows. Following the address field 418 is Identifier 2 field 416b. Here, Identifier 2 is used to indicate that the second piece of data to report is timestamp. Field 420 is used to report the timestamp. Once again, even though field 420 appears to be spread over two rows, it comprises 4 contiguous bytes in an actual packet. Following the timestamp fields is Indicator 3 field 416c. This field is labeled to indicate the third piece of data to report is packet count. Following field 416c is packet count field 422. Packet count field 422 also comprises 4 contiguous bytes even though it appears to be spread over two rows in FIG. 4a. In FIG. 4a, a 1-byte code is used for identifiers. It should be clear, however, that any suitable length could be used to identify the data that needs to be reported. Similarly, any suitable lengths can be assigned to the timestamp and packet count fields.

After the source client appropriately fills in each Identifier field, the source client fills the Address field 418 with its network address, Timestamp field 420 according to its clock time and initializes the “Packet Count” field 422 to 1 before it transmits the first packet with the QoS-Reporting extension header. From this point on, the source client keeps track of the total number of packets transmitted for the flow, and fills in the “Packet Count” field with the latest such packet count whenever it inserts a QoS-Reporting extension header into a packet belonging to that flow. The Timestamp field 420 is filled with the current clock time.

After creating and filling in all of the desired fields within the QoS-Reporting option, the source client 105 fills the rest of the packet headers such as header extension length field 430 which is used to indicate the total length of the extension header and then transmits the packet toward the next node, e.g., router 110a, on its path.

In step 305 of FIG. 3, router 110a in FIG. 1 receives data packet 400 with the extension header 402 carrying a QoS-Reporting option shown as the shaded portion of FIG. 4a. The routing node examines the initial packet of the data flow, first checking for the destination address. After determining the destination of the data flow, the routing node checks the extension headers, specifically Hop-by-Hop extension header 402. By checking the Option Type field 404 included in the extension header, the routing node determines the extension header is a hop-by-hop extension header being used to collect statistical performance data. Router 110a determines what specific performance data needs to be monitored and reported for the corresponding data flow based upon Number of Metrics field 412 and Identifier fields 416a, 416b and 416c.

As indicated by the Identifier fields, the data to be monitored are the node address, the timestamp for the current packet before transmission and the aggregate packet count for the data flow. Therefore, router 110a sets up a counter to keep track of the number of packets received for the data flow, initializing it to 1 since the first packet belonging to the data flow has just been received. This counter is updated whenever a packet belonging to that data flow is received by Router 110a.

FIG. 4b illustrates what hop-by-hop extension header 402 looks like after router 110a has updated the QoS-Reporting option. First, router 110a increments “Number of Node Reports” field 410 by 1 so that it equals 2 now. Router 110a then appends to the QoS-Reporting option the appropriate fields and corresponding identifiers as needed to report the requested data. First it appends a new “Identifier for Node Position” field 434 and fills in the field with a 1 representing router 110a's position in the path. Next, router 110a follows the same steps as source client 105 with respect to reporting data. First, router 110a includes an identifier for node address and provides its network address. Next, router 110a includes an identifier for timestamp and includes the current clock time. Finally, in this example, router 110a includes an identifier for packet count and includes the current packet count. After reporting the requested data, router 110a sets the Option Length field 406 to reflect the new length of the QoS-Reporting option fields, which is now indicative of the data filled in by the source client 105 as well as router 110a.

Router 110a then sets “Header Extension Length” field 430 appropriately to reflect the added information to the extension header and forwards the packet to the next hop toward the destination as shown in Step 310 of FIG. 3. Similar to above, the next receiving node checks the destination address and determines if it is the final destination of the data flow in step 315. If the next receiving node is not the final destination, the process returns to step 305 whereupon actions similar to those discussed in the context of router 110a are executed. If, on the other hand, the receiving node is the intended recipient, the process proceeds to step 320.

In step 320, the destination node for the data flow, destination client 115 in the present example, receives the data packet with a QoS-Reporting extension header. If the data packet is the first packet with a QoS-Reporting extension header, the destination client sets up tables, counters, etc. to collect and compile the performance data desired by the source client 105. After that, for each packet belonging to the data flow that has a QoS-Reporting extension header, the destination client 115 collects the performance data reported in the extension header by the different nodes in the data path, and processes this data to obtain the desired performance measures. In the present example, this processing includes recording the node addresses on the data path that are reported in the header, end-to-end packet delay which equals the difference between the current time and the timestamp reported by the source client 105, per-hop packet delays which equal the difference in the timestamps reported by a node and its predecessor node in the data path, overall packet loss which equals the difference between the packet count reported by the source client and the packet count measured by the destination client, and the per-hop packet losses which equal the difference between the packet counts reported by a node and its successor node in the data path. Once the destination node has the desired performance data, it can do several things dependent upon the network structure. Several possibilities include the destination node transmitting the data back to the source node, the destination node transmitting the data to a centralized storage server where any node on the network can access the information, or the destination node broadcasting the information to all the nodes in the network.

After transmitting this first packet, the source client periodically, e.g., once every 100 packets inserts the QoS-Reporting extension header into outbound packets belonging to the data flow. Whenever a node on the data path encounters a packet with a hop-by-hop extension header carrying a QoS-Reporting option, it reports, in the manner described above, its local performance data that corresponds to the performance metrics included in that packet by its source.

Every time the source client transmits a packet with a QoS-Reporting option, it need not include all of the performance metrics that were included in the QoS-Reporting extension header of the first packet. For instance, if the source client desires reports on packet losses every 200 packets and on packet delays every 100 packets, it can perform the following steps. First, it can include a QoS-Reporting extension header into every 100^{th} outbound packet. However, every such extension header will include the Timestamp metric from which packet delays are inferred, whereas the Packet Count metric will be included in every second such extension header. The Node Address field also need not be included in every QoS-Reporting extension header. This feature enables network entities to report and compile different performance metrics at any desired frequency, thus affording flexibility and efficiency to the performance data collection process.

It is also possible to have a QoS-Reporting extension header with a “null” QoS-Reporting option, which contains nothing other than the “Sequence Number” field, which is entered into the option field by the source client as mentioned before. FIG. 4c shows a schematic of a hop-by-hop extension header with a null QoS-Reporting option. Since a null QoS-Reporting option does not contain any fields for performance reporting, it is not altered by any node on the path between the source and destination. However, the Sequence Number field included in the null QoS-Reporting option is exploited to obtain certain useful performance metrics. For instance, if the source client is interested in “consecutive packet loss” for a data flow, it can include a hop-by-hop extension header with a null QoS-Reporting option in every packet belonging to that flow. The “Sequence Number” field included in this option helps nodes on the path as well as the destination client to determine consecutive packet loss for that flow. By periodically including the “Consecutive Packet Loss” identifier and a field for reporting consecutive packets lost in the QoS-Reporting option of its outbound packets, the source client can prompt nodes on the data path to report their recorded consecutive packet loss values to the destination client. Thus, for instance, if the source client would like to have consecutive packet loss reported every 100 packets, it can do the following: First, the source client includes the QoS-Reporting option with the Consecutive Packet Loss field in the first packet belonging to the data flow as well as every 100^{th} packet thereafter whereas it includes the null QoS-Reporting option in all other packets belonging to that data flow. This enables the source client to monitor the performance of given nodes in the network without actually transmitting a data flow with a defined payload. Over a given sequence of packets, a node can experience multiple, disjoint consecutive packet loss instances. For example, over a 100-packet sequence of a data flow, a node may experience two instances of consecutive packet losses where 5 consecutive packets are lost in the first instance and 10 in the second instance. The remaining 85 packets are received correctly. In such cases, the node reports the larger of the consecutive packet loss counts when it fills in the Consecutive Packet Loss field for a given data flow. Thus, in the present example, it will fill the Consecutive Packet Loss field with the value 10.

The embodiment shown in FIGS. 3, 4a, 4b and 4c is merely shown by way of example. One of ordinary skill in the art will recognize additional embodiments and advantages not fully illustrated above. For example, another embodiment of the present invention includes sporadically sending out a test data flow from a node on a specific network segment. This test data flow is similar to the above embodiment explained in FIGS. 3, 4a, 4b and 4c, with the exception that no real data is included with the flow as the flow is merely used to monitor performance.

While certain preferred embodiments of the invention have been described, these embodiments have been presented by way of example only, and are not intended to limit the scope of the present invention. Accordingly, the breadth and scope of the present invention should be defined only in accordance with the following claims and their equivalents.

1. A method of monitoring and recording performance levels of a data network, the method comprising the steps of:
(1) initiating a data flow at a source node;
(2) forwarding said data flow through said network from said source node to said destination node;
(3) recording statistical information at said destination node, said information relating to a current performance level of said network.

2. The method of claim 1, wherein said step (1) further comprises including an extension header in a packet of said data flow, said extension header specifying performance information to be collected at each node in said network.

3. The method of claim 2, wherein step (2) further comprises updating said extension header at any intermediate node along a route between said source node and said destination node, said updating including adding said performance information as specified by said extension header.

4. The method of claim 3, wherein said step (3) comprises recording at said destination node said performance information for each intermediate node.

5. The method of claim 4, wherein said performance information comprises data from which can be derived end-to-end packet delay, per-hop packet delay, packets received, consecutive packet loss, total packet loss, and packet jitter.

6. The method of claim 5, wherein said data flow is initiated as a test flow and contains no payload.

7. The method of claim 2, wherein said extension header is a hop-by-hop extension header as defined by Internet Protocol version 6.

8. A method for monitoring performance levels of individual nodes on a source-destination path in a data network, the method comprising the steps of:
(1) initiating at a source node a data flow to be delivered to a destination node, said data flow periodically including a packet with an extension header for reporting performance information;
(2) forwarding packets associated with said data flow to said destination node through said data network;
(3) determining at said destination node statistical information relating to a current performance level of said network.

9. The method of claim 8, wherein said extension header specifies performance information to be collected at each node in said network.

10. The method of claim 9, wherein step (2) further comprises updating said extension header at any intermediate node along a route between said source node and said destination node, said updating including adding said performance information corresponding to said intermediate node as specified by said extension header.

11. The method of claim 10, wherein step (3) comprises recording at said destination node said performance information for each intermediate node.

12. The method of claim 11, where said recorded performance information is distributed to at least one other node in said data network.

13. The method of claim 11, wherein said performance information comprises data from which can be derived end-to-end packet delay, per-hop packet delay, packets received, consecutive packet loss, total packet loss, and packet jitter.

14. The method of claim 13, wherein said data flow is initiated as a test flow and contains no payload.

15. The method of claim 8, wherein said extension header is a hop-by-hop extension header as defined by Internet Protocol version 6.

16. A data structure embodied on a computer readable medium, said data structure comprising a hop-by-hop extension header as defined by Internet Protocol version 6, said extension header comprising:
an option type field for reporting a type of said extension header;
an option length field for reporting the length of said extension header;
a sequence number field for indicating a position of a packet in a data flow;
a number of node reports field for indicating a number of nodes in a network that have contributed data to said extension header;
a number metrics field for indicating a number of pieces of data to be reported in said extension header;
a node position field for indicating a position of reporting node in said network;
identifier fields for indicating the types of data to be reported in said extension header; and
data fields for reporting actual data corresponding to said identifier fields.

17. The data structure of claim 16, wherein said identifier fields comprise:
a node address field for indicating a physical address of a reporting node;
a timestamp field for indicating a time when a reporting node processes said data packet;
a packet count field for indicating a total number of packets received at a reporting node;
a total packet loss field for indicating a total number of packets lost at each reporting node;
a consecutive packet loss field for indicating a consecutive number of packets lost at each reporting node; and
a per hop jitter field for indicating the delay jitter at each reporting node.

18. The data structure of claim 17, wherein there is at least one data field corresponding to each identifier field, said data field containing the physical value of the statistic indicated by said identifier field.
